(19) United States
(12) Patent Application Publication
(10) Pub. No.: US 2026/0267404 A1
(43) Pub. Date: Sep. 10, 2026

(54) METHOD AND SYSTEM FOR EYE TRACKING USING DEFLECTOMETRIC INFORMATION

(71) Applicants: Florian Willomitzer, Tucson, AZ (US); Arizona Board of Regents on Behalf of the University of Arizona, Tucson, AZ (US)

(72) Inventor: Florian Willomitzer, Tucson, AZ (US)

(21) Appl. No.: 19/163,125

(22) PCT Filed: Mar. 8, 2024
(86) PCT No.: PCT/US2024/019011

§ 371 Date: Sep. 8, 2025

Related U.S. Application Data
(60) Provisional application No. 63/489,157, filed on Mar. 8, 2023.

(51) Int. Cl. G06F 3/01; G06T 7/73

(52) U.S. Cl. CPC G06F 3/013; G06T 7/75; G06T 2207/30201

(57) ABSTRACT

Methods and systems are described that use deflectometric information for precise and fast eye tracking. An example method for determining a gazing direction of an eye includes determining one or more reference correspondences based on one or more images corresponding to a reflected pattern from the eye that is illuminated with a known illumination pattern. The method further includes determining one or more candidate correspondences in a virtual environment and using an optimization technique to iteratively change a location or orientation of the eye model in the virtual environment a predetermined criterion is satisfied. The gazing direction of the eye in then determined based on the orientation of the model eye when the predetermined criterion is satisfied. The described eye tracking techniques can be implemented in, for example, virtual reality (VR), augmented reality (AR), or mixed reality (MR) headsets.

### CROSS-REFERENCE TO RELATED APPLICATION(S)

This application claims priority to the provisional application with Ser. No. 62/489,157, titled “Method and System for Eye Tracking Using Deflectometric Information,” filed Mar. 8, 2023. The entire contents of the above noted provisional application are incorporated by reference as part of the disclosure of this document for all purposes.

### TECHNICAL FIELD

The disclosed technology relates to methods and systems for eye tracking.

### BACKGROUND

In recent years, the need for a robust, fast, and precise solution to estimate the human gaze direction has evolved into a central unsolved problem in augmented reality (AR) and virtual reality (VR) headset research. In consumer devices, sophisticated eye tracking would enable a higher quality graphics experience through foveated rendering—i.e., reducing or shifting the rendering workload by deemphasizing the image quality in the peripheral vision outside of the zone gazed by the fovea—or would significantly improve the interaction with virtual avatars. Other applications include using the gaze direction to control interaction with a computer (e.g., navigating a scene, typing, and the like) that would require accuracies similar to using a mouse. In a battlefield context, a precise eye tracking solution in AR headsets can be used to estimate and monitor the health status of the soldier (e.g., level of fatigue) and can help to significantly increase the headset's viewing comfort by continuously keeping track of the inter-pupillary distance (“accommodation convergence reflex”). Moreover, tracking the gaze of the soldier in a combat situation can deliver important data about which information displayed in the AR headset he is actually really using. Ultimately, precise eye tracking can compensate for imperfections of other system sensors, e.g., for position/location estimation. Eye tracking and determination of gaze direction is also employed in other fields, including but not limited to, behavioral sciences and psychology. Despite the obvious need for a precise eye tracking solution, the current state of the art leaves much room for improvement.

### SUMMARY

The disclosed embodiments relate to methods and systems that use deflectometric information (information gained from the reflection of an extended light source on a specular surface) for precise and fast eye tracking. An example application of the disclosed embodiments includes implementation in virtual reality (VR), augmented reality (AR), and mixed reality (MR) headsets. The disclosed embodiments can be implemented using light that in practically any wavelengths or range of wavelengths, including in visible spectra and infrared spectra.

One example deflectometric method for determining a gazing direction of an eye includes determining one or more reference correspondences based on one or more images corresponding to a reflected pattern from the eye that is illuminated with a known illumination pattern, determining one or more candidate correspondences in a virtual environment based on rendering of a reflected pattern from an eye model in response to illumination by a virtual illumination pattern mimicking the known illumination pattern, using an optimization function to iteratively change a location or orientation of the eye model until a departure of the one or more candidate correspondences from the one or more references satisfy a predetermined criterion; and determining the gazing direction of the eye based on the orientation of the model eye when the predetermined criterion is satisfied.

### BRIEF DESCRIPTION OF THE DRAWINGS

FIG. 1 illustrates determination of the gazing direction based on deflectometry in accordance with some example embodiments.

FIG. 2 illustrates a configuration for determining gazing direction in accordance with an example embodiment.

FIG. 3 illustrates a configuration for determining gazing direction in accordance with another example embodiment.

FIG. 4 illustrates eye base shape and example screen illumination renderings in accordance with some example embodiments.

FIG. 5 illustrates the overall eye setup and procedure for eye tracking using deflectometric correspondences in accordance with some example embodiments.

FIG. 6 illustrates a side cross section view of a low polygon version of an eye model that is used for optimization in accordance with some example embodiments.

FIG. 7 illustrates example eye shapes before and after optimization procedures in accordance with example embodiments.

FIG. 8 illustrates example display patterns and eye renderings used for the comparison of our techniques to prior methods.

FIG. 9 illustrates a comparison graph of gaze direction errors obtained using various techniques.

FIG. 10 illustrates a single frame deflectometry network (SFDN) architecture for determining azimuth and elevation angles in accordance with an example embodiment.

FIG. 11 illustrates a double frame deflectometry network (DFDN) architecture for determining azimuth and elevation angles in accordance with an example embodiment.

FIG. 12 illustrates an example comparison between the images obtained using Pytorch3D model and the Swirski model.

FIG. 13 illustrates sample images from six datasets of images that include different patterns for Pytorch3D and Swirski models.

FIG. 14 illustrates example DFDN error values based on datasets described in FIG. 13.

FIG. 15 illustrates an example comparison of images where the length and count of eyelashes are randomized.

FIG. 16 illustrates an example comparison of images for a fully open and partially open eye.

FIG. 17 illustrates an example comparison of images obtained with and without a out displacement modifier.

FIG. 18 illustrates an example comparison of images obtained with an all-white illumination pattern and a sinusoidal illumination pattern.

FIG. 19 illustrates a set of operations that can be carried out to determine a gazing direction of an eye in accordance with an example embodiment.

FIG. 20 illustrates a set of operations that can be carried out to determine a gazing direction of an eye in accordance with some embodiments.

### DETAILED DESCRIPTION

Current eye tracking techniques either utilize two-dimensional (2D) features detected from 2D eye images or exploit sparse reflections of a few point light sources at the eye surface (“corneal/scleral reflections”). Image-based methods retrieve geometrical information about the gaze direction from 2D features in captured 2D images of the eye. Pupil, iris, limbus, or eyelids are popular candidates for 2D features to calculate eye position and gaze direction. Although some techniques flood-illuminate the eye for better visibility (e.g., with infrared light), those methods can be considered as “passive” methods since the illumination is not actively modulated in space or time. Traditionally, classic computer vision techniques, such as edge detection and model fitting, are utilized to find the 2D features in the eye images. Recently, machine learning and deep learning techniques have been employed to achieve better feature extraction quality. However, image-based approaches still rely solely on 2D image space information, although explicit 3D information about the eye can lead to better and more robust tracking. Moreover, the density of extracted 2D features is still relatively sparse, which impedes the reconstruction quality. Lastly, most image-based models fail to capture the light transport complexities of the lens surface of the eye. The refraction of light at transparent eye parts like iris or pupil can cause view-dependent deviations in apparent feature locations, making it difficult to model these optical complications using a purely image-based approach. To circumvent this problem, current approaches often resort to rely on unreliable secondary features, such as face and skin movement, to predict the eye gazing directions.

The second class of methods exploit the (partial) specularity of the eye surface to capture real 3D information that is then used to calculate the gazing direction. A prominent example of such “reflection-based methods” is “glint-tracking”: the reflections of a few sparse (infrared) point light sources is observed with a camera over the reflective cornea surface. The position of the corneal reflections in the camera image changes depending on the rotation and translation of the eye. These changes in position are used in conjunction with other eye features, such as the pupil position and geometry, to evaluate the gaze direction. Over the years, the point light source arrangements have evolved from single point lights (or “glints”) with one camera, to multi-view, and multi-point-source setups, with more sampled surface points generally leading to higher accuracy in gaze evaluation. However, although the number of reflection points that sample the eye surface has increased, state-of-the-art methods still use only roughly ~12 reflection points. Compared to the number of pixels in the camera image space, this is still very sparse, and hence only sparse surface information from the eye can be extracted.

In the disclosed embodiments, measured surface samples lead to a more precise estimation of the gazing direction. This thrust aims to significantly increase the information content provided by corneal or scleral reflection to calculate the gazing direction. To make this possible the number of light sources observed over the eye surface must be significantly increased.

The disclosed embodiments utilize deflectometry. Deflectometry is an established method in surface metrology to reconstruct the 3D surface of specular objects, such as freeform lenses, car windshields, or technical parts. A screen displaying a known pattern (e.g., a sinusoid) is observed over the specular surface of an object under test (in this case, the human eye). From the deformation of the pattern in the camera image, the normal vectors of the surface (and eventually the surface shape via integration), as well as information about the rotation and translation of the measured eye, can be calculated. The inherent depth-normal-ambiguity can be solved by adding a second camera, which results in a so-called “stereo-deflectometry” system. The disclosed embodiments utilize deflectometry for a dense and precise measurement of the eye surface. For example, an extended self-illuminated screen (e.g., an HD display with 1920×1080 pixels) yields more than 2M point light sources, which in comparison to the current state of the art (e.g., 12 sparse points), an increase in data density by a factor >170,000 is easily achievable.

The disclosed techniques in some embodiments, among other features and benefits, utilize a single-shot procedure of deflectometry for a dense, precise, and fast measurement of the eye surface. In some implementations, to calculate the gazing direction, we first trace back the measured surface normal vectors toward the center of the eye. Due to the vastly different radii of cornea and sclera, the back-traced surface normals aggregate at two points inside the virtual 3D eye model: the center of the corneal sphere and the center of the scleral sphere. We can then calculate the gazing vector by estimating the sphere centers from the back-traced normals with a closest point algorithm. In an experiment, we have shown that a precision in gaze direction evaluation below 0.5 degrees can be achieved.

It should also be noted that in the disclosed techniques, a second screen that emits visible light is not necessary. In order to not disturb the person, the illumination can be in infrared (IR), which is invisible to the human eye. A more sophisticated possibility is not to use a second screen at all and utilize the visual information displayed on the VR/AR headset's main screen as the “pattern” for the deflectometry measurement. Besides the described aspect of robust, precise, and fast eye tracking, other aspects such as how stress and fatigue of, for example, soldiers during battlefield situations can be actively analyzed and monitored by leveraging the increased information content of our disclosed methods. For example, a comprehensive model that utilizes not only the evaluated gazing direction, but also deformations of the periocular region, paired with other acquired vitals such as pulse, blood pressure, etc., can be used.

In some aspects of the disclosed embodiment, different techniques can be used alternatively, or in combination, to evaluate the gazing direction. For example, one technique that uses a single-shot deflectometry can be used to measure the eye surface and extract the gazing direction from measured surface features. In another technique, a virtual eye model and inverse rendering are used to calculate the gazing direction from the captured deflectometric information. In yet another technique, a machine learning-based method that uses the captured deflectometric information can be used to evaluate the gazing direction via deep learning. These techniques can be used in the alternated, or in combination, depending on the application, the level of accuracy needed and/or feasibility of resources.

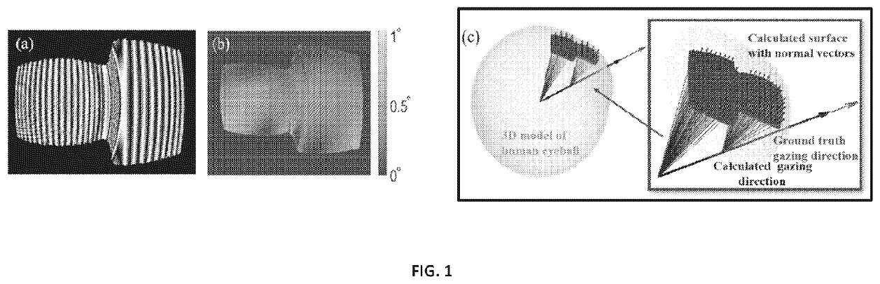

FIG. 1 illustrates determination of the gazing direction based on deflectometry in accordance with some example embodiments. Panel (a) illustrates an image of an example sinusoidal screen pattern is reflected from the eye surface, e.g., reflections captured from a part of cornea and a portion of sclera. Panel (b) illustrates an error map (in degrees) which is the calculated normal map with respect to the ground truth. In panel (c), calculation of the gazing direction is illustrated; this calculation includes, after obtaining the surface normals corresponding to the corneal and scleral areas, tracing back the measured surface normals to the scleral and corneal center. The vector that connects the two centers is an estimate of the gazing direction. The right side of panel (c) illustrates a magnified view, and shows a calculated (i.e., estimate) gazing direction that is substantially the same as the ground truth gazing direction.

The feasibility of the disclosed techniques can be demonstrated using a simulation. In one example, we simulated a screen of size 10.6 cm by 6 cm and two identical cameras whose optical axes enclose an angle of 15°. A 3D model of a human eyeball was placed at 6 cm standoff to the screen. To achieve more realistic simulation results, we added 5% photon noise in our simulated camera images. The normal map of the eye surface was obtained from phase shifting sinusoidal fringes on the screen, and the surface shape was calculated from a combination of the stereo deflectometry algorithm with iterative surface integration. Eventually, the gazing direction was evaluated with the previously described approach. The results are shown in FIG. 1, as previously described. The calculated gazing direction was recovered with an absolute error angle of 0.43° relative to the ground truth gazing direction. Repeating the simulation experiment 96 times for randomized eye rotation angles delivered calculated gazing directions with a root-mean-square error (RMSE) of 0.34° with respect to the ground truth.

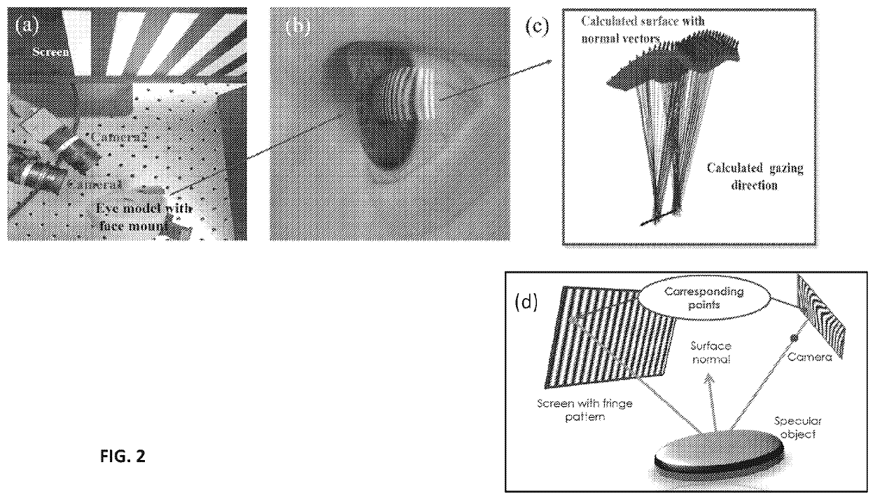

FIG. 2 illustrates a configuration for determining gazing direction in accordance with an example embodiment. Panel (a) in FIG. 2 shows a prototype that can be used to experimentally determine the gazing direction. The prototype includes two cameras (FLIR-fl3-u3-13s2c) and a 26 cm×12 cm computer screen, with a geometrical arrangement similar to the simulated setup described earlier. In particular, in panel (a) two cameras (camera 1 and camera 2) were positioned such that their optical axes enclose an angle of 15°. A physical eye model was placed on a mount and a screen was used to illuminate the eye model. The object (eye model) was a realistic model of a human eye with elevated cornea, as illustrated in panel (b). The reflected screen (sinusoidal) pattern is also shown in panel (b). The calculated 3D surface together with the captured surface normals and the evaluated gazing direction vector can be seen in panel (c). It should be noted that the disclosed embodiments do not require two cameras, and the choice of using two cameras in this experimental setting was made in order to obtain better images of the cornea (using camera 1) and sclera (using camera 2).

These results demonstrate an improved methodology for determining gazing direction that is based on acquiring dense deflectometric information of the eye surface and calculating the gazing direction from the measured surface normals. Notably, by using a large screen (relative to the size of the eye) that includes many pixels, each representing a point source, the eye can be illuminated with a pattern (e.g., sinusoidal pattern) and the reflected pattern can be used to (1) determine correspondences between illumination point sources and the detector pixels (or group of pixels). This information can be used in turn to determine a surface normal for each pair of points (see panel (d) of FIG. 2), and to obtain the gazing direction as described earlier. Using this technique, our results indicate that an RMSE of at least 0.34° with respect to the ground truth gazing direction can be obtained. While not all human eyes have a perfectly spherical cornea and sclera surface, the disclosed gazing direction techniques deliver good results as long as the respective shapes of cornea and sclera are rotationally symmetric around the optical axis of the eye. In this case, all back-traced normals meet along the optical axis (which defines the gazing direction) instead of at two distinct points.

In the sections that follow, further details and examples related to the deflectometry techniques based on optimization and inverse rendering are described. Notably, in some embodiments, a differentiable deflectometry shader that simulates specular reflection light transport from an area illumination is described, and used to estimate the rotation, translation, and shape of a virtual eye model placed in a virtual deflectometry setup identical to the real setup. We exploit image-screen-correspondence information from the real measurements to guide our virtual eye to accurate parameters through gradient descent. Our experiment results show that our method achieves <1° of mean gaze error in a real experiment setting. In a simulation experiment, our method achieves over 6× better error results than previous reflection-based method that uses sparse point light simulation.

In some example embodiments, we exploit the densely captured deflectometric information of the eye surface (i.e., the screen reflection observed over the eye surface), but employ an inverse-rendering procedure to evaluate the eye's rotation and translation parameters. For example, we can generate a realistic virtual eye model that we place in a virtual copy of our (calibrated) experimental setup. By comparing the rendered images of the virtual eye with our real measurements, we can optimize the eye's rotation and translation through gradient descent. Simultaneously, our differentiable renderer also allows for gradient descent optimization over an objective function that captures the fitting of the 3D information of the eye surface between the real eye and the virtual eye, meaning that we can jointly optimize for gaze direction and eye shape. Our technique can operate with only one camera. Moreover, we can facilitate any possible pattern/image that is displayed on the screen. In the end, the need for a second “pattern-screen” included in the VR/AR/MR headset can be eliminated. We simply use the main screen of the headset and its actual displayed VR/AR/MR content (movie, video game stream, etc.) to evaluate the gaze direction and eye shape. This process can be performed solely from a single-shot capture, allowing for motion robust eye tracking solutions with the lowest possible latency.

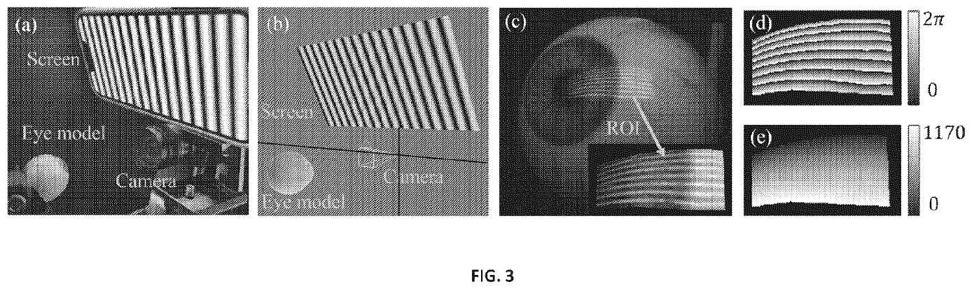

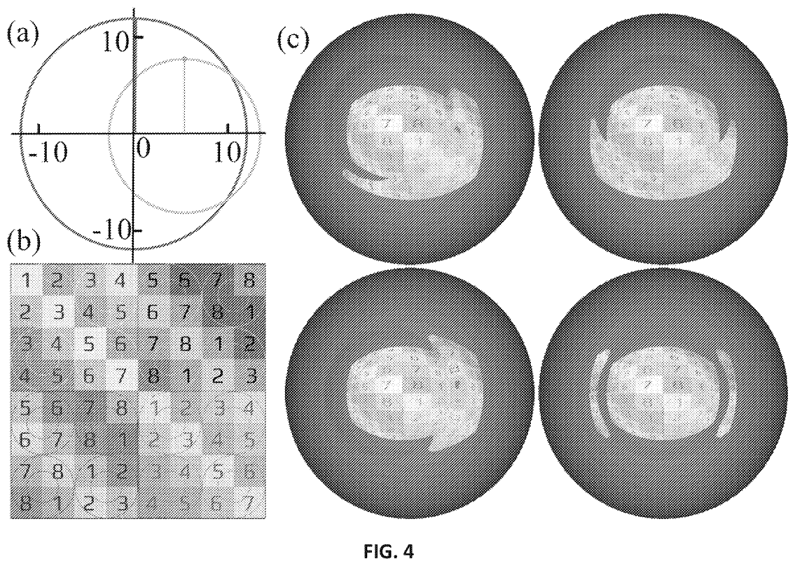

Example Gaze Estimation via Differential Rendering: With a calibrated screen-camera setup, we capture one image (or potentially more images) of the eye with screen reflection, denoted as {I^{gt}} (see panel (c) of FIG. 3). Our goal is to estimate the rotation, translation, and shape of the eye. We approach this goal by formulating a joint optimization problem of the eye parameters. We define the true rotation, translation, and shape of the eye during each measurement as the parameter set v. The goal of our inverse rendering optimization procedure is to find the optimal parameter set v* using a simulated base eye model (see FIG. 4) and the observed view of the camera {I^{gt}}. This optimization is performed by minimizing a pre-defined objective function, denoted as L:

$${v}^{*} = arg min L ( I ( v ) , v ; \{ {I}^{gt} \} ) \qquad ( 1 )$$

We minimize our objective using gradient descent. The function I represents the differentiable rendering function that takes in the eye parameters v. Our differentiable rendering module and our eye parameter representation and optimization strategy are described later in this patent document. We note that the captured eye image {I^{gt}} is the crucial input of our algorithm, as our loss function L is dependent on the information we extract from the captured eye image.

In the following sections, we will introduce two different differential rendering-based eye-tracking procedures from deflectometric measurements: one extracting 3D screen-camera image correspondence information decoded from the deformed patterns of the captured image(s), and another leveraging directly the intensity values of the captures image and calculating the “photometric loss”.

Our setup for capturing the screen-illuminated eye images includes a camera and a rectangular screen that displays a pattern (e.g., a sinusoid). FIG. 3 illustrate an example experimental setup in panel (a) that illustrates a screen (mobile phone screen) displaying a sinusoidal pattern for illuminating an eye model, as well as a camera for capturing the reflected pattern from the eye. This basic setup in FIG. 3 is similar to that in FIG. 2, but a single camera is used. Panel (b) shows an image of our example simulated setup (that similarly includes a screen, an eye model and a camera) that we use to develop our differential rendering algorithms and to compare our method with other techniques. Notably, in panel (b), the wireframe represents the camera, with two perpendicular lines that represent the X and Y axis of the camera space. The basic idea is to calibrate the real system to know the exact location of the camera with respect to the screen and camera parameters. Then to obtain a picture of the actual setup with the eye model in place. On the virtual side, the position of the camera with respect to the screen is known; the eye model is positioned into the virtual scene (e.g., at an arbitrary rotation/position), is then moved and rotated while the renderer produces the corresponding images, and a loss function is optimized until a match to the real image is obtained. As described below, different loss function and optimizations can be utilized, including optimization based on correspondences and based on photonic loss or intensity.

Referring back to FIG. 3, panel (c) illustrates a captured sample image of the region of interest (ROI) of the eye model, illuminated with a high frequency (8 periods) vertical sinusoid pattern. Panel (d) shows the wrapped phase map retrieved using a phase shifting method, and panel (e) is the unwrapped phase map corresponding to the screen pattern, ranging from 0 to 16π. In our real-world experiment, our measurement object is a realistic 3D eye model that is mounted on a rotation stage. We emphasize again that screen and camera in our setup are calibrated, i.e., the intrinsic camera parameters as well as the position of the screen relative to the camera is known within the bounds of the calibration error. The intrinsic parameters comprise camera characteristics and describe the mapping of the outer world (world coordinates) onto the camera chip. This also includes, e.g., imperfections of the objective lens (distortions) and the like.

Modeling Eye Anatomy and Geometry: The human eye is a highly complex organ that has been the subject of extensive research and analysis with regards to its anatomy and geometry. Our eye tracking approach utilizes a virtual 3D model of the human eye. Hence, anatomic knowledge is crucial for improving the quality of gaze estimation algorithms. We concentrate our modeling efforts on a realistic representation of the eye surface, in particular, the region around the limbus—the transition between cornea and sclera. It has been shown that, due to the prominent surface feature at the limbus, this region is especially suitable to extract information about the gazing direction. Using statistical size metrics obtained from literature, we create our eye base model on the assumption that the surfaces of sclera and cornea are both spherical in shape, with the sclera having a larger radius of 12 mm and the cornea having a smaller radius of 8 mm the distance between the two sphere is approximately 5 mm (see panel (a) in FIG. 4, where the smaller circle represents the cornea and larger circle represents the sclera). The result is an overlapping sphere model of the eye as the base shape. As discussed further below, we employ iterative shape optimization on the simulated base eye model to obtain an even more realistic eye shape and to compensate for individual deviations of the “common” eye shape, e.g., for cornea deformations.

Differentiable Deflectometry Rendering: The differentiable deflectometry rendering function allows the eye parameters to properly update towards low error gaze estimation. We utilize the PyTorch3D framework, which is a rasterizer-based differentiable renderer that provides the necessary tools to perform differentiable transformations from virtual world space to virtual image space using a perspective camera model. This framework also allows to find the closest intersection between a camera ray and the mesh geometry, providing us with object surface depth and normal information for each pixel or our rendered virtual object. However, native PyTorch3D does not support indirect lighting or area lighting calculations. To overcome this limitation, we designed a specialized deflectometry shader that simulates specular reflection from area lighting. Our shader acts as a single bounce ray-tracer that calculates the mesh position and object surface normal for each camera image pixel using the PyTorch3D rasterizer. The view direction is calculated as a vector originating from each camera pixel and pointing toward the mesh position. The specular reflection ray is then computed by reflecting each view direction vector at the surface of the mesh with the surface normal obtained from the PyTorch3D rasterizer. Intersecting the specular reflection ray with the screen delivers the intensity value at the respective pixel (shown as different colors or shades in FIG. 4) and establishes correspondence between simulated screen and simulated camera.

FIG. 4 illustrates an example eye base shape and example screen illumination renderings in accordance with some embodiments. Panel (a) illustrates an example base eye shape, where the surface of the eye is formed by the union of a larger sphere (12 mm) of the sclera and a smaller sphere (8 mm) of the cornea. The distance between the centers of the two spheres is approximately 5 mm. Panel (b) illustrates a displayed color coded illumination pattern, and panel (c) shows example renderings of our base eye model under four different gaze angles. By implementing our lighting calculation as a PyTorch module and utilizing the differentiable rasterizer in PyTorch3D, we have created a completely differentiable rendering pipeline for deflectometric measurements that enables us to optimize scene parameters, such as the rotation and translation of the mesh geometry as well as the mesh itself, through gradient descent.

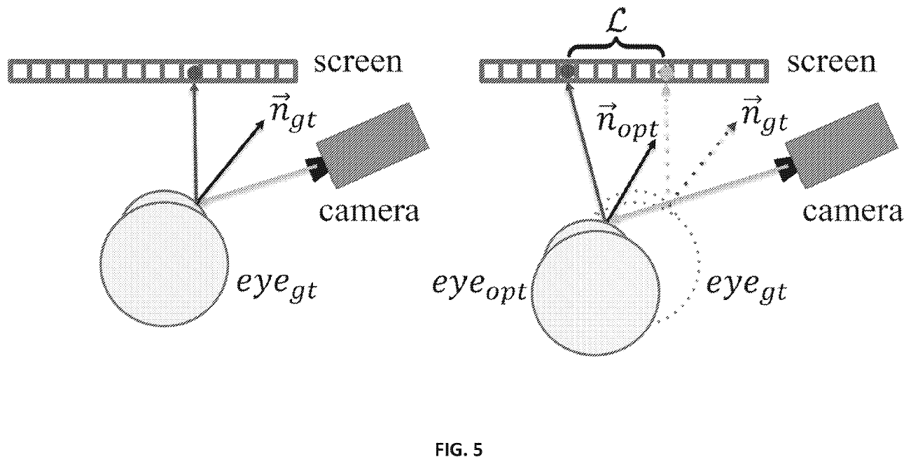

Eye Tracking Using Deflectometric Correspondences: We now go into detail on gaze estimation using screen-image correspondence information. FIG. 5 illustrates the overall eye setup and procedure for eye tracking using deflectometric correspondences in accordance with some example embodiments. In particular, we illuminate the eye using sinusoidal patterns, and obtain pixel-dense ground truth screen, image correspondence points. The left diagram in FIG. 5 shows correspondences between two point, but it is understood that this is extended for a plurality of illumination and detection points. Our differentiable renderer then simulates the deflectometry setup in the virtual scene and attempts to find the correct eye parameter by minimizing screen correspondence point distances between simulation and ground truth (or a reference correspondence point). For example, as illustrated in the right diagram in FIG. 5, the ground truth (gt) correspondence (lighter circle in the row of screen pixels) does not coincide with the estimated correspondence (darker circle in the row of screen pixels). As part of the optimization process, the virtual eye model is moved based on optimization (minimization) of the distance (L) (or a function thereof).

We obtain correspondence using standard procedures of optical 3D imaging as found, e.g., in deflectometry, or active triangulation (structured light): Structured patterns are displayed on the screen and reflected over the eye surface, and the deformed pattern in the eye image is then decoded to calculate a correspondence between screen pixels and camera pixels. In our experiments, we utilize various patterns to extract this correspondence information, balancing the density of correspondence points and the number of shots. For instance, we can display a single checkerboard pattern and utilize checkerboard corner detection algorithms to extract correspondence points from the corners of the pattern in single-shot. We also can display sinusoidal fringe patterns and obtain pixel-dense correspondence via, e.g., the four phase-shift algorithm and phase unwrapping-however at the cost of multiple sequentially captured images. For the mentioned arbitrary image content of movie video frames or video game streams in VR, we can use scale-invariant feature transform (SIFT) feature matching to extract correspondence information between the display image and its distorted pattern on the eye. Other patterns/images and correspondence evaluation methods are possible as well. Related experiments and quantitative comparisons are described further below in this patent document.

After establishing correspondence between screen pixels and camera pixels, we represent the set of image pixel positions as P_{corr}={p}, and the corresponding sub-, pixel precise location on the screen as {corr(p)}. The set of correspondences (p,corr(p)) is the input to our differentiable rendering optimization pipeline. Our differentiable renderer takes (p,corr(p)) and attempts to optimize a model in a virtual deflectometry setup to fit the measured correspondence set with the simulated correspondence set as follows: In our virtual model, we trace rays through the same set of virtual image pixels P_{corr}. By simulating the specular reflection light transport at our virtual eye model surface, we obtain the intersection location between virtual reflected rays and virtual screen plane, denoted as {corrₒₚₜ(p)}. The difference between {corr(p)} and {corrₒₚₜ(p)} is dependent on the base eye model's shape, rotation, and translation in virtual space.

We normalize the screen correspondence points to a 2D planar coordinate system so that the point coordinates that directly hit the screen have values between −1 and 1. For our given image pixel positions P_{corr}, we can now calculate the squared distance between the measured correspondence points {corr(p)} and the rendered screen plane intersection points {corrₒₚₜ(p)}. Our optimization objective is then to minimize the mean of the log of this squared distance for all obtained correspondences.

$$L = \frac{1}{\vert {P}_{corr} \vert} {\sum }_{p ∈ {P}_{corr}} dist ( {‖ corr ( p ) - {corr}_{opt} ( p ) ‖}^{2} ) , \qquad ( 2 a )$$

where we have:

$$dist ( d ) = \{ \begin{matrix}d & d \leq 1 \\ log ( d ) + 1 & d > 1\end{matrix} \qquad ( 2 b )$$

Note that the log is only applied in the rare cases when the distance between the correspondence points is larger than 1 (half of the screen dimension) and would cause large values in the loss function. In general, the optimization aims to arrive at results where the distance between the correspondences is within a predetermined criteria, such as zero, a minimum value, or within an acceptable range such as within one unit.

Eye Tracking Using a Photometric Loss: In the previous discussion, we introduced our pipeline that uses screen-camera image correspondence information to find the eye gaze direction. We mentioned that, e.g., SIFT features can be used to extract correspondence information for arbitrary images. However, the displayed VR content might lack large numbers of features in certain situations, e.g., if texture-less low-frequency images (sky, water, etc.) are displayed. Another possibility is that the displayed features are too distorted in the camera image (see, e.g., panel (c) in FIG. 3) and cannot be detected properly. In these cases, the previously described correspondence method becomes unreliable. For this reason, we implemented a second flavor of our method that optimizes rotation, translation, and shape of the eye model based on “photometric loss,” i.e., by directly comparing the intensity values in each camera pixel (I_{gt}(p)) with the intensity values in the simulated image (Iₒₚₜ(p)). In our differentiable renderer pipeline, we now use the objective of the photometric loss, which is the mean absolute per-pixel RGB intensity difference between the captured camera image and the optimized renders.

$$L = \frac{1}{\vert P \vert} {\sum }_{p ∈ P} \vert {I}_{gt} ( p ) - {I}_{opt} ( p ) \vert \qquad ( 3 )$$

As will be shown later in this document, in general, the photometric loss method delivers a slightly higher gazing estimation error than the correspondence method. For this reason, it should be seen more as a “backup-addition” to the correspondence method for the cases where no correspondences can be found.

Optimizing the Eye Shape: Our method uses a differentiable renderer to simulate deflectometric images of a virtual eye model in a virtual scene, where the eye model is moved/rotated in the virtual space based on the gradient descent optimization. This means that our method heavily relies on a realistic shape of the used eye model. For real-world experiments it is possible that the shape of the measured eye is different for different subjects, e.g., if a user has corneal deformations. For an improved robustness of our technique, it is therefore necessary to develop additional methods to accommodate for varying eye shapes.

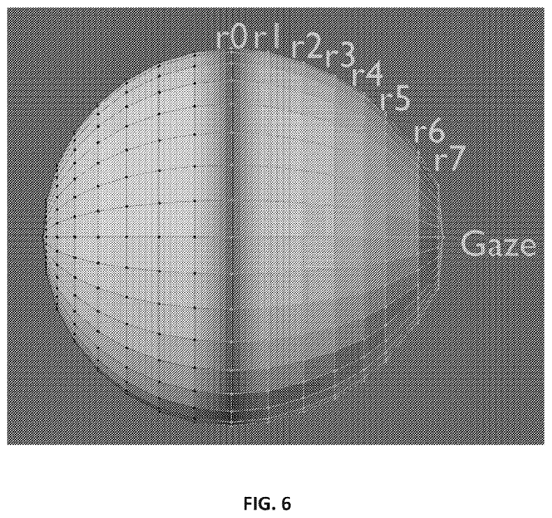

In some embodiments, we take advantage of our differentiable rendering framework and jointly optimize for the shape of the virtual eye model along with its translation and rotation. For example, the optimization process can jointly optimize the eye shape and deflectometric correspondences, which amounts to optimization based on additional parameters. One typical method to perform shape optimization is to directly optimize for the position of the vertices of the mesh, or optimize a per-vertex displacement field on top of a base mesh. However, we found that directly optimizing on the whole mesh introduces a very high dimensional optimization space that often leads to local minima. For this reason, we imply an additional constraint on the eye shape that drastically reduces the optimization space: We assume that the eye is rotationally symmetric around its optical axis. Under this assumption, we can model the shape of the eye as a set of connected circular edge loops, all centered around the optical axis. Our shape consists of the vertices V∈ [symbol] ^{HXN}, where V is the number of edge loops, and H is the number of vertices for each edge loop. Setting the axis of rotation of the eye model is the local Z axis, and the center of the (initially spherical) sclera is at the origin, we can define c₀<c₁< . . . <c_{N-1} as the z coordinates of the center of the N edge loops. If we then define the radii of the N edges loops as r₀, r₁, . . . , r_{N-1}, then the 3D local coordinate of the i^{th} vertex of the j^{th} vertex loop can be written as (rⱼ cos(2πi/H), rⱼ sin(2πi/H, cⱼ). During our shape optimization, we optimize the radii of the edge loops R={r₀, r₁, . . . , r_{N-1}} for the frontal part of the eye model. FIG. 6 visualizes the basic idea for shape optimization parameters and geometry for N=8 edge loops. For our experiments we chose the number of edge loops and the number of vertices within each edge loop to be 100. In particular, FIG. 6 shows a side cross section view of a low polygon version of the eye model (N=8), the circular edge loops that we optimize for and their corresponding radii (the shaded loops for r₀, the r₇).

Although this procedure greatly simplifies the shape optimization problem, a joint optimization of radii along with the translation and rotation could easily lead to local minima which result wrong shapes. To address this, we utilize additional regularizers to the eye geometry to favor smooth shapes without undesirable bumps. This step is inspired by previous works that involve the use of differentiable rendering for inverse problems, and regularize both the radii gradient L_{geom}, the local radii smoothness L_{mc}(R) and the Laplacian of the mesh M, Lₗₐₚ(M). These regularizers are controlled by hyper-parameters λ_{grad}, λ_{mc}, λₗₐₚ

$${L}_{geom} ( R , M ) = {λ}_{grad} {L}_{grad} ( R ) + {λ}_{mc} {L}_{mc} ( R ) + {λ}_{lap} {L}_{lap} ( M ) \qquad ( 4 )$$

We first regularize the gradient of the radii so that the radii form a monotonically decreasing sequence from the circle closest to the center to the furthest, which is in accordance with the anatomy of a real eye.

$${L}_{grad} ( R ) = {\sum }_{i} max ( 0 , {r}_{i} - {r}_{i + 1} ) \qquad ( 5 )$$

Second, we regularize the smoothness of the radii. This is to prevent the eye surface from being uneven. Our smoothness formulation can be written as

$${L}_{mc} ( R ) = {\sum }_{i} max ( MC ( {r}_{i} , {r}_{i + 1} , {r}_{i + 2} ) - {t}_{mc} , 0 ) \qquad ( 6 )$$

Here MC is the discrete Menger curvature of three points, where a larger Menger curvature means a more curved surface. In other words, we apply a threshold t_{mc} on the local curvature of the surface.

Lastly, we add the mesh Laplacian as a regularizer to further enforce smoothness of the optimized mesh.

$${L}_{lap} ( M ) = ‖ LV \vert \qquad ( 7 )$$

L is the vector of vertices in the mesh and V is the laplacian matrix of the mesh. In our experiments, we typically set λ_{grad}=0.05, λₗₐₚ=0.1. For Menger curvature smoothness, we typically set λ_{mc}=0.1, t_{mc}=4.

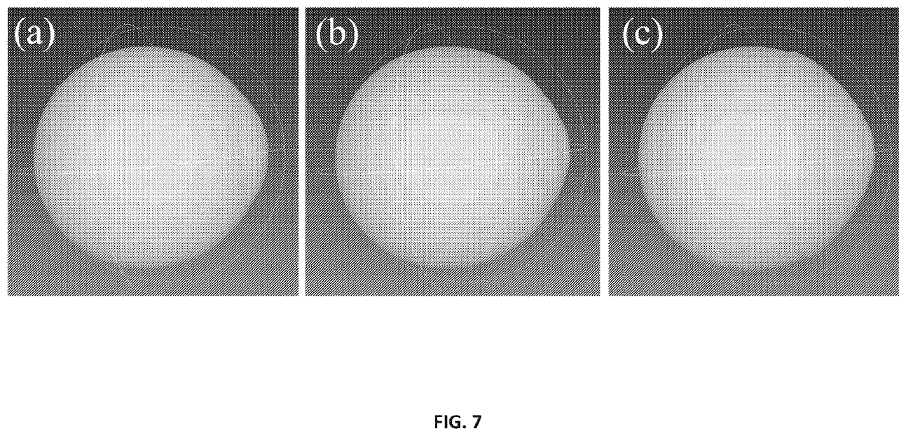

FIG. 7 illustrates eye shape before and after optimization. In particular, panel (a) shows an example base eye shape, panel (b) illustrates the optimized eye shape, and panel (c) illustrates the optimized eye shape, without regularizers.

We emphasize again that the disclosed shape optimization not only leads to a more precise gaze estimation, but also delivers a shape of the eye model that is much closer to the shape of the real eye of a subject. Moreover, the shape optimization will deliver different eye shape results for different subjects. In some embodiments, our shape optimization algorithm can be used to accurately measure the eye surface during eye tracking. This would allow, e.g., for the automatic correction of vision impairments and could potentially lead to “self-correcting” VR headsets.

Example Experimental Results: To validate our joint shape and gaze optimization model in a quantitative fashion, we conducted real-world experiments on a realistic 3D eye model that emulates the reflective properties of a human eye. Our experimental setup (including 3D eye model) is shown in FIG. 3 (panel (a)), and a closeup view of the eye model is shown in panel (c) of FIG. 3. We used an iPhone13Pro as screen (1170×2530 pixels) and a FLIR fl3-u3-13s2c as camera. The distance of the camera to our eye model was approximately 8 cm, meaning that the prototype setup was already very compact.

As discussed, our algorithm does not know the shape of the measured object (the 3D eye model) in advance, only the calibrated camera and screen position. Since the absolute ground truth gaze direction of the eye model cannot be evaluated, we used relative gazing angles for our quantitative error evaluation: we centered the 3D eye model on a rotation stage and rotated the 3D eye model multiple times to −4°, −2°, 0°, 2°, and 4°. At each rotation position, we took a measurement of the 3D eye model and moved to the next rotation position. We took 20 measurements at each of the 5 rotation positions, i.e., 100 measurements in total. We emphasize that we always rotated the 3D model before we took a measurement, meaning that we never took two consecutive measurements at the same rotation position. In this experiment our screen displayed a phase-shifted sinusoidal pattern in the horizontal and vertical direction, respectively. The used sinusoidal pattern had 16 periods in the horizontal direction and (according to the screen aspect ratio) 7.4 periods in the vertical direction. The acquired phasemaps were unwrapped with MATLAB's unwrap( ) function, which works sufficiently well for low noise levels and smooth surfaces.

For each of the 5 rotation positions r, we calculated the precision σᵣ of our measurements, which is defined as the standard deviation of the 20 acquired measurements:

$${σ}_{a} = \sqrt{\frac{{\sum }_{i}^{n} {( {θ}_{a , i} - {\overline{θ}}_{a} )}^{2}}{n}} \qquad ( 8 )$$

Here, θ̅ₐ is the mean evaluated gazing angle at each rotation position a, θ_{a,i} is the a^{th} measurement at rotation position a, and n=20 in this experiment. Moreover, we define the mean relative error ϵ₀ of the gazing direction at each rotation position a with respect to the rotation position a=0° as

$${ϵ}_{0} = \vert {\overline{θ}}_{a} - {\overline{θ}}_{0} \vert \qquad ( 9 )$$

We note that, due to the definition of our mean relative error, the values with respect to other rotation positions are slightly different.

The results of our experiment are shown in Table 1. In Table 1, “rotation position” specifies the amount of rotation of the model eye on the rotation plate with respect to a reference position (0 deg). We can see that with geometry regularizers the average error is than 1 degree for all experiments. Both datasets use the CG eye model shape optimization via radial loop optimization. If we apply the radial loop optimization together with the additional regularizers of Eq. (5), (6), and (7), we achieve precision values between 0.11° and only 0.02° and a mean relative error ϵ₀ with respect to a=0° between 0.45° and only 0.27°. This demonstrates the robustness of our joint shape and gaze optimization model for real world experiments.

We additionally conduct an ablation study on the effect of our shape regularizers (also shown in Table 1): If we only use the radial loop optimization without the additional regularizers of Eq. (5), (6), and (7), we generally achieve a slightly worse mean relative error and comparable values for the precision. This indicates that the shape regularizers have little effect on the statistical variance of the evaluated results, but help to converge to a result with overall smaller estimation error.

TABLE 1
Example Experimental Eye Tracking Error Results

| Rotation position | 0 deg | 2 deg | 4 deg | −2 deg | −4 deg |
|---|---|---|---|---|---|
| Precision σₐ | 0.02 | 0.10 | 0.08 | 0.11 | 0.11 |
| Mean relative error ϵ₀ | 0 | 0.33 | 0.28 | 0.27 | 0.45 |
| σᵣ w/o shape regularizer | 0.04 | 0.02 | 0.05 | 0.09 | 0.06 |
| ϵ₀ w/o shape regularizer | 0 | 0.01 | 0.49 | 0.44 | 1.17 |

It should be noted that we conducted the experiment above with a rotation stage that was rotated by hand. This might have imparted an additional angular variance on the measurements that propagates through our evaluations to our results. The usage of a high-precision automated rotation stage potentially yields even better results.

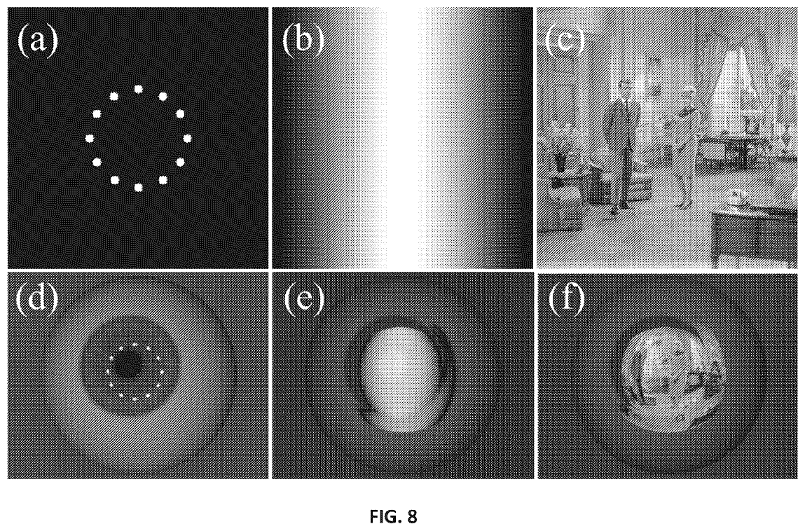

Comparison to Glint-based Eye Tracking: In this section the disclosed differentiable rendering optimization techniques are compared to state-of-the-art glint tracking gaze estimation techniques. Particularly, we follow a representative method that uses an interpolation-based technique that utilizes the pupil center and a ring of 12 glint illumination sources. FIG. 8 illustrates example display patterns and eye renderings used for the comparison of our techniques to prior methods. Panels (a) to (c) show a glint tracking pattern, a sinusoid pattern, and a living room image pattern, respectively. Panels (d) to (f) are corresponding rendered images. We use our simulation pipeline to generate images of our CG eye model with corneal glint reflections (see panel (d) of FIG. 8). Moreover, we implemented the algorithmic steps described in the paper by Clara Mestre, Josselin Gautier, and Jaume Pujol, titled “Robust eye tracking based on multiple corneal reflections for clinical applications,” Journal of biomedical optics, 23(3):035001, 2018, to evaluate the gaze direction for each of our generated images. We compared our implementation of Mestre technique against our optimization frameworks using either correspondence loss, or photometric loss. For both of our methods, we use a sinusoid pattern with 1 period in horizontal screen direction (see panels (b) and (e) in FIG. 8). For the correspondence loss method, we phaseshift the sinusoid to extract the correspondences, while we only use one sinusoid image (single-shot) for the photometric loss method. It is, however, understood that this technique can also be implemented using multiple images, as previously described. Additionally, we perform a simulated experiment where we display an arbitrary image (‘living room’), which is representative for movie content or a video game stream that is displayed on the VR/AR/MR headset (see panels (c) and (f) in FIG. 8). We use the top 50 closest SIFT feature matches between the “living room” image (panel (c)) and the rendered eye image (panel (f)) to extract image-screen correspondences for our correspondence-loss method. As we only use one image per gaze direction evaluation, this procedure is also single-shot.

One important restriction of the implementation the glint tracking method is that the point source reflections always need to “stay” on the cornea, which restricts the allowed movement of the eye. We therefore limited our eye movement to rotations only and set the translations to 0 for this experiment. We tested all methods under the same set of 50 random gaze angles with the elevation and azimuth of the gaze both under ±5 degrees. For all simulated images, we applied an additional 5 percent Poisson noise to simulate camera shot noise.

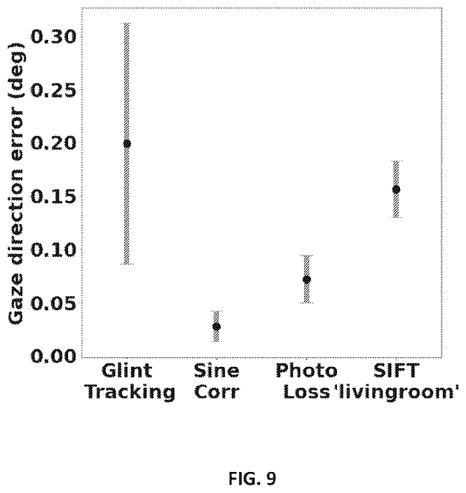

Our results are summarized in FIG. 9, which compares our deflectometry optimization-based method, using either correspondence or photometric loss, with point light interpolation-based methods in terms of eye gaze direction accuracy. For our example method, single frequency sinusoid patterns were displayed for both loss cases. For each of the different methods, we calculated the mean error of all measurements with respect to the ground truth gazing directions Eq. (9) (shown as point), as well as the precision Eq. (8) (shown as bar). Correspondence loss performs the best in terms of average gaze direction error. It can be seen that, compared to the glint tracking implementation, our correlation-loss and photometric-loss methods achieve a much lower error in eye gaze direction estimation. This demonstrates that (1) the additional dense information from an extended light source compared to discrete glint illumination, and (2) explicitly utilizing the 3D modeling information in the 3D scene, contributes to the low error in eye gazing performance. We also note that the “living room” experiment using SIFT features also achieved competitive performance, with an average gaze error that is still better than the gaze error for glint tracking (0.15° vs.) 0.2° and a much better precision. We also note that our simulated result of the glint tracking method is better than the results specified in the original paper by Mestre et al. This could be caused by the absence of our periocular region (eyelids, lashes, etc.) in simulation that could occlude the eye, as well as by a slight mismatch in noise levels between simulation and real experiment.

Experimenting with Increasingly Sparser Correspondences: To further quantify the advantage or a dense deflectometric surface information, we conducted an additional experiment, similar to the experiment described earlier in connection with FIG. 3. We ran our pipeline several times while artificially thinning out the measured correspondence points in a random fashion, resulting in measurements with increasingly sparser correspondences. Our results in Table 2 show that the dataset with the full correspondence delivers the best result in terms of both precision and mean error and that the performance decreases with decreasing number of correspondence points.

TABLE 2
Example Gaze Direction Results for Increasingly
Sparser Amounts of Correspondence

| Completeness | Full | 1/50 | 1/100 | 1/200 | 1/500 |
|---|---|---|---|---|---|
| Precision | 0.19° | 0.23° | 0.28° | 0.54° | 4.52° |
| Mean error | 0.42° | 0.63° | 0.51° | 0.71° | 1.52° |

It is evident that our optimization-based eye tracking framework takes advantage of screen illumination on the specular eye surface. Our differentiable pipeline that accurately simulates specular reflection and extracts useful 3D information to guide our optimization, and to enhance our model to form accurate surface representations of the eye. Our methods outperform existing reflection based methods, and the dense correspondence we obtain from screen illumination is crucial to the success of our method. We believe that our approach to eye tracking could be suitable for accurate and ubiquitous near-eye tracking, and provides a potential solution for eye tracking in VR devices.

It should be noted that our shape optimization process operates under the assumption of rotational invariance around the gaze axis, ignoring potential asymmetrical deformations of the cornea and sclera. To address this issue, we can consider a coarse-to-fine optimization approach for our shape optimization pipeline to introduce local deformations, or we can consider different optimization parameters, such as sphere radii and relative position. Additionally, to improve the pipeline when using the photometric loss as the optimization objective, we can jointly optimize the reflectance map of the eye along with the periocular region. In our experiments, we only use one single camera view to perform our optimization, but the results can be further be improved by employing a stereo or multi-view setup, as it adds coverage to the reflection area of the eye. The disclosed methodology extends easily to a multi-view setup as long as the cameras are calibrated, each camera can optimize the eye parameters using its own correspondence.

To provide a summary of some of the disclosed embodiments, it is evident that our approach uses dense deflectometric information together with an optimization-based framework that leverages differentiable rendering to determine the eye's translation and rotation parameters. To facilitate the various operations disclosed herein, we developed a custom differentiable deflectometry shader on top of the PyTorch3D renderer that simulates the light transport from a pattern screen illumination on a specular object, such as the eye. We further developed different variations of our technique that utilize different information from the captured images (such as correspondences or photometric loss), each variation providing certain benefits, which may be suitable for a different application scenario. In particular, we demonstrated how our methods does not require a second “pattern-screen” at all and uses only the information displayed main AR/VR/MR screen (movie, video game stream, etc.).

Compared to the current state-of-the-art method for active eye tracking, our method provides a 6× improvement in both the mean and standard deviation of the gaze error. Notably, our methods are shown to produce precisions in gaze estimation between 0.11° and only 0.02° and relative gazing errors between 0.45° and only 0.27°.

Further, we can extend our framework to jointly optimize gaze direction and the shape of the virtual eye base model. For real-world experiments, this allows for a more realistic representation of the real eye, which in turn allows better evaluation results and additional potential features, such as in-headset automatic vision correction.

Eye Gaze Estimation based on machine learning techniques using Deflectometry Information: In some embodiments, faster and more precise eye gaze direction estimates can be obtained in VR/AR/MR devices by exploiting the deflectometric information provided from the reflection of the screen pattern on the specular surface of the eye. As mentioned earlier, unlike existing learning-based approaches which “only” use captured images of the eye and its periocular region, or sparse reflections of point light sources to estimate the gazing direction, the disclosed systems exploit full-field deflectometric information provided by a reflected screen pattern. In some example embodiments, a neural network can be utilized for performing some of the operations. In some embodiments, improvements can be achieved by randomizing various periocular features of the eye to mitigate its influence on the gaze estimation learning process. Furthermore, we realized that simply predicting two rotation angles of the eye-azimuth and elevation-leads to ambiguity when we attempt to predict captured eye images that have nonzero translation and rotation with respect to the camera coordinate system. In example applications in VR/AR/MR headsets, this would be the cases in some actual settings, where minor translations and rotations of the headsets are present as users move their heads around. Therefore, the position of the eye with respect to the camera is not always fixed. To avoid ambiguity and to ensure the robustness of our neural network to minor translations and rotations of the head within the headset, we modify our networks to predict six degrees of freedom of the eye with respect to the camera coordinate system instead of only predicting the two rotation angles under the certain assumption of the head, eye, and camera locations. We use our modified network trained from synthetic images to predict six degrees of freedom of the captured eye images in a real experimental setup and share our result.

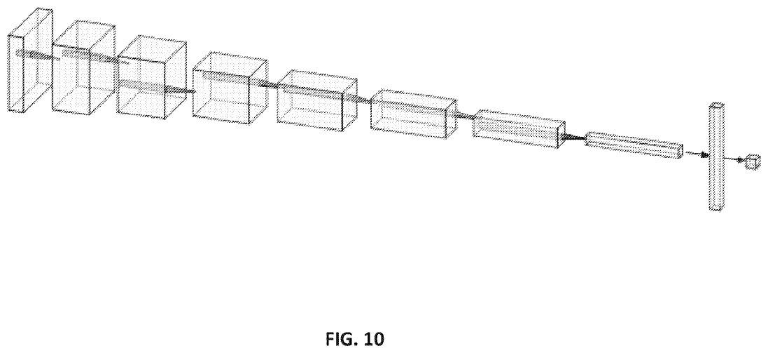

An example of a single frame deflectometry network (SFDN) architecture is shown in FIG. 10. The input to the network is a single eye image and it predicts two rotation angles of the eye: azimuth and elevation. While the estimation error for SFDN on images synthesized with Pytorch3D model using a sinusoidal pattern is very low, reaching, e.g., 0.347 degrees, SFDN can only work well with a fixed pattern that it was trained with. However, the error increases significantly if the SFDN which is trained on one pattern is to be used to predict an eye image with different screen patterns reflected. The requirement of a fixed pattern transfers over to the actual design of the VR/AR/MR headsets, as it requires a secondary screen to be installed to project a fixed pattern. Therefore, the usefulness of the SFDN may be limited to only certain applications.

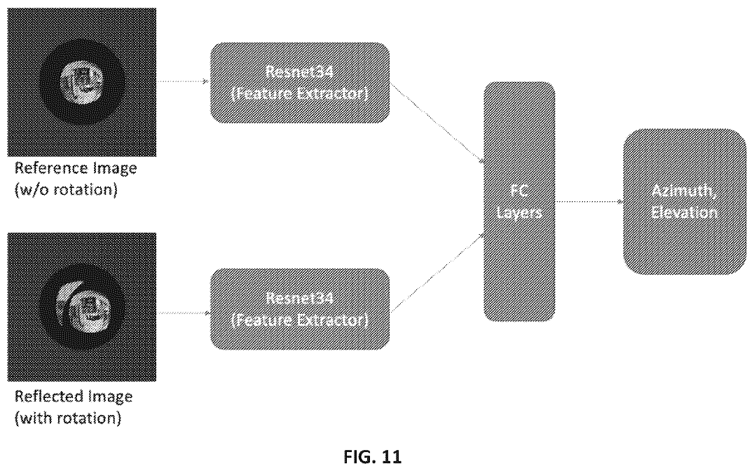

An example of a double frame deflectometry network (DFDN) is shown in FIG. 11, which works well with arbitrary patterns and would allow arbitrary screen patterns for the inputs. DFDN can take a pair of eye images, where one is an actual captured image and the other is a synthesized eye image with preset rotation angles and the reflection of an arbitrary pattern. We call the latter a reference image. A reference image plays a role of providing the network some information about the arbitrary pattern that is being reflected on the captured eye image. As shown in FIG. 11, the two images are provided to the feature extraction module (e.g., Resnet 34), and to FC layers, which can determine azimuth and elevation. In particular, the DFDN learns the relationship between the screen pattern of a captured image and that of a reference image to estimate the gaze direction based on the deformation of the pattern due to the rotation of the eye. The advantage of DFDN is that it removes the need for a secondary screen inside the headset and instead uses the main screen directly as the pattern. The DFDN architecture can be implemented to provide a very low average error of e.g., 0.968 degrees.

Eye simulation models in which the periocular region of the eye is not randomized may have certain errors. The periocular region of the eye includes all the surrounding features such as the eyelashes, the shape of the skin, and how closed the eye is. Intuitively, the shape of the periocular region should also play an important role in predicting gazing direction because as the eye rotates, the shape of the periocular region also changes. For example, when we look up, our eye is nearly completely open whereas when we look down, our eye is nearly half shut. However, this strong correlation can be problematic when we want to clearly isolate the effect of the pattern on the estimation accuracy. When we compare the results of DFDN on the images generated by the Pytorch3D model and the images generated by the Blender Swirski model, the problem is evident. The main difference between the Pytorch3D model and the Swirski model is the presence of the periocular region. The Pytorch3D model shows only the eyeball whereas the Swirski model includes the full periocular region of the eye.

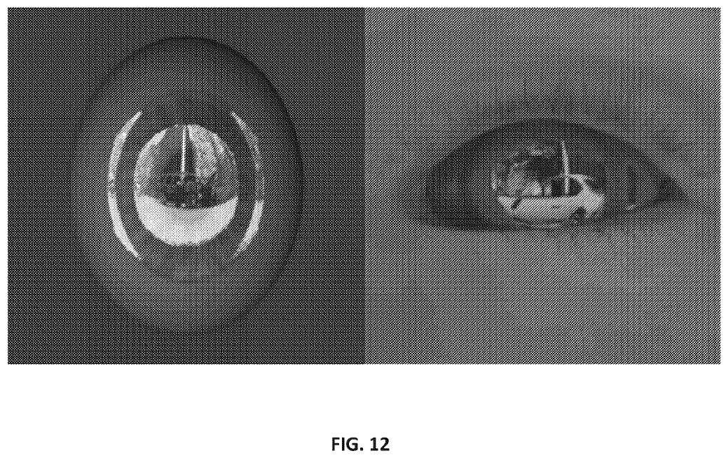

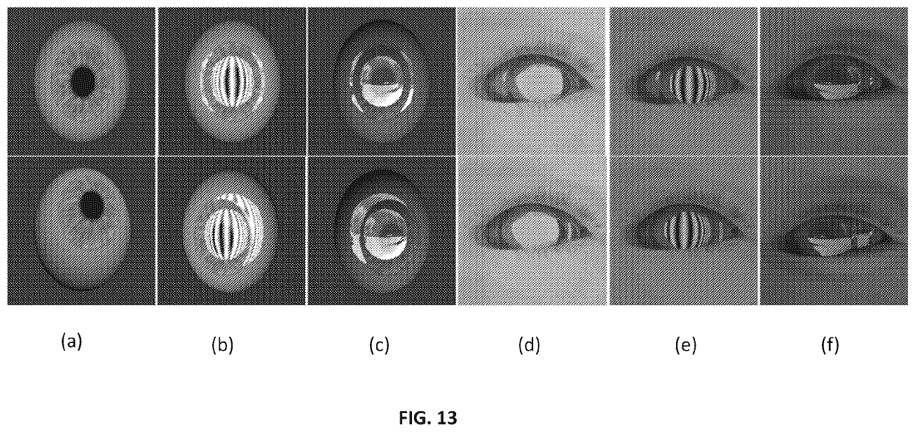

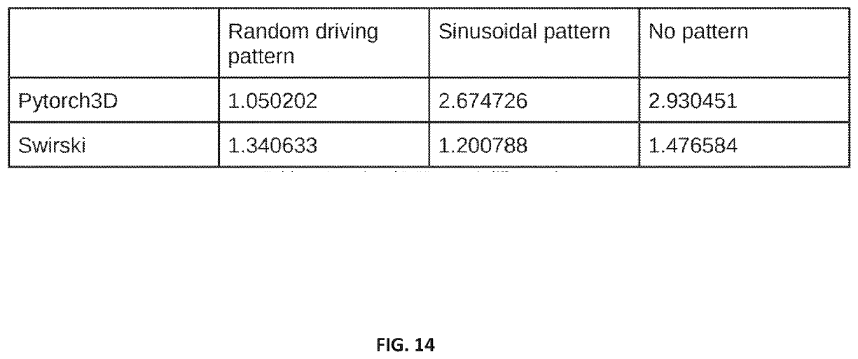

FIG. 12 shows such a comparison between the results obtained using Pytorch3D model and the Swirski model. The Swirski model contains a periocular region whereas the Pytorch3D model does not. FIG. 13 shows sample images from 6 datasets of 10,000 images that were generated: (no pattern, Pytorch3D-panel (a)), (sinusoidal pattern, Pytorch3D-panel (b)), (random driving pattern, Pytorch3D-panel (c)), (no pattern, Swirski-panel (d)), (sinusoidal pattern, Swirski panel (e)) and (random driving pattern, Swirski-panel (f)). Top row in FIG. 13 shows the reference images and bottom row shows the randomly rotated images. For each dataset, we split it into 8,000 for training, 1,000 for validation, and 1,000 for testing. FIG. 14 shows the results of DFDN on various patterns prior to any randomization of the periocular regions.

The results on Swirski generated images indicate that the sinusoidal pattern performs the best, arbitrary driving scene the second, and no pattern the third. However, we observe that the arbitrary driving scene patterns yield the lowest error by a significant margin in Pytorch3D generated dataset, whereas the differences in errors among different patterns in the Swirski model are minimal. The minimal difference in error can be due to the presence of the periocular region in the Swirski model, and the introduction of periocular regions can dominate the estimation process over the pattern. The shape of the periocular region as the eye rotates follows certain rules of motion in the Blender model, and accordingly, the network can learn the shape of the periocular region to determine the rotation angle.

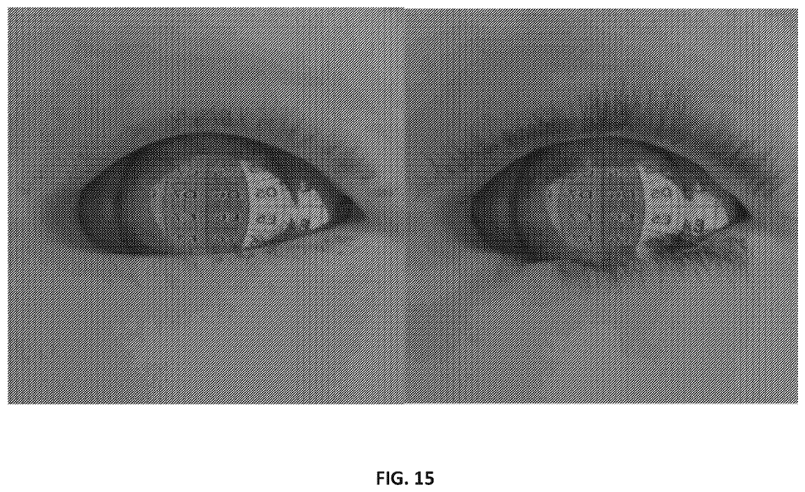

In some embodiment, we update our rendering pipeline to randomize various features of the periocular region for every render. We first randomize the length and the number of eyelashes. For example, on average, humans have 90 to 160 eyelashes on the upper lid and 75 to 80 eyelashes on the lower eyelid. Lash length varies by individual, it typically does not grow beyond a certain length, usually less than 12 mm. Using metrics, such as those described above, we randomize the length and the count of eyelashes to be between these ranges. FIG. 15 illustrates the comparison, where the length and count of eyelashes are randomized.

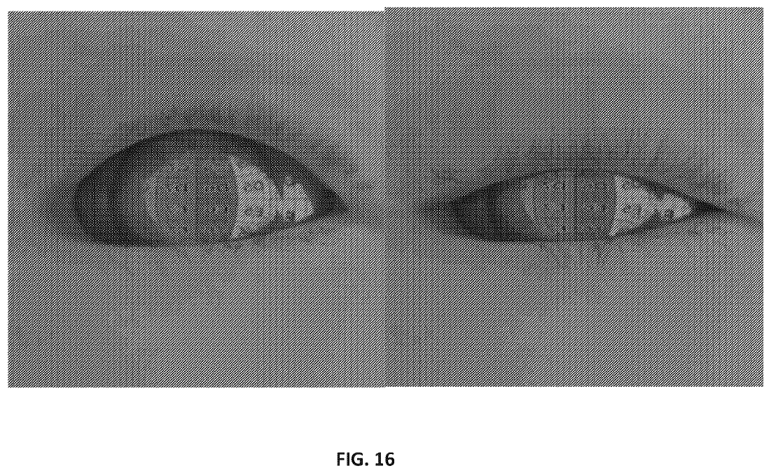

We also randomize how closed the eye is. For example, the eye is completely shut when eye closedness is equal to 1 and is completely open when it is equal to 0. In one implementation, we randomized eye closedness to be between 0 and 0.3 for every render. FIG. 16 shows the comparison. In particular, the left image has eye closedness of 0, and the right image has eye closedness of 0.3.

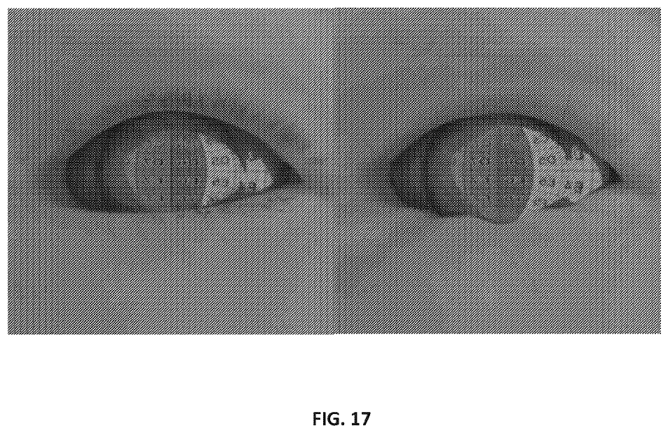

According to some embodiments, we further implemented a random displacement modifier to displace the vertices of the face mesh around the eye to give a slightly different outlook of the skin around the eye for every render. In effect, this operation adds random distortion and wrinkles to the periocular region to prevent the network from gathering clues from the geometry of the skin to predict the angle. FIG. 17 shows a comparison, in which the left panel is obtained without displacement modifier, and the right panel is obtained with the displacement modifier, illustrating a slight distortion of the mesh around the eye.

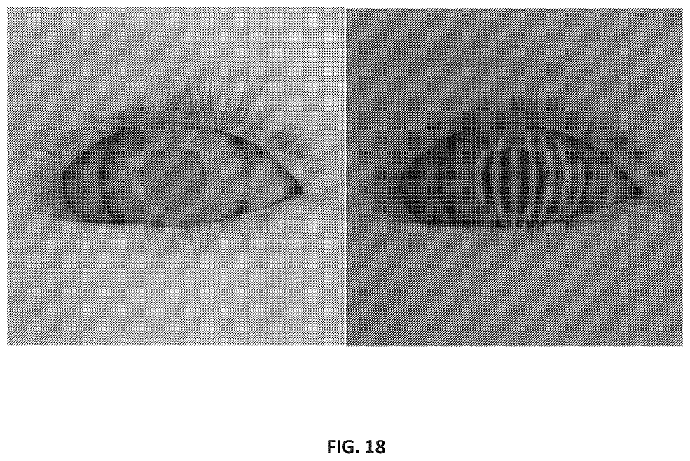

Effects of various pattern frequencies on estimation accuracy: With the randomization of the periocular region correctly applied, the effects of various pattern frequencies on estimation accuracy can be obtained. The process can include testing various hypotheses on the properties of patterns that may affect the accuracy, and finding the optimal pattern that yields the lowest error. One example is as follows. Consider an all-white pattern and a sinusoidal pattern. When both of the patterns are reflected from the eye, the distortion of the reflection of the all-white pattern due to the rotation can only be observed at the boundary of the pattern, whereas the distortion of the sinusoidal pattern can be seen at every period. The amount of information that the sinusoidal pattern provides is much greater than that of the all-white pattern. This is illustrated in FIG. 18. Based on this premise, it may be concluded that the higher the frequency of the pattern, the lower the estimation error. In some implementations, we can systematically control the frequency of the pattern and compare the results.

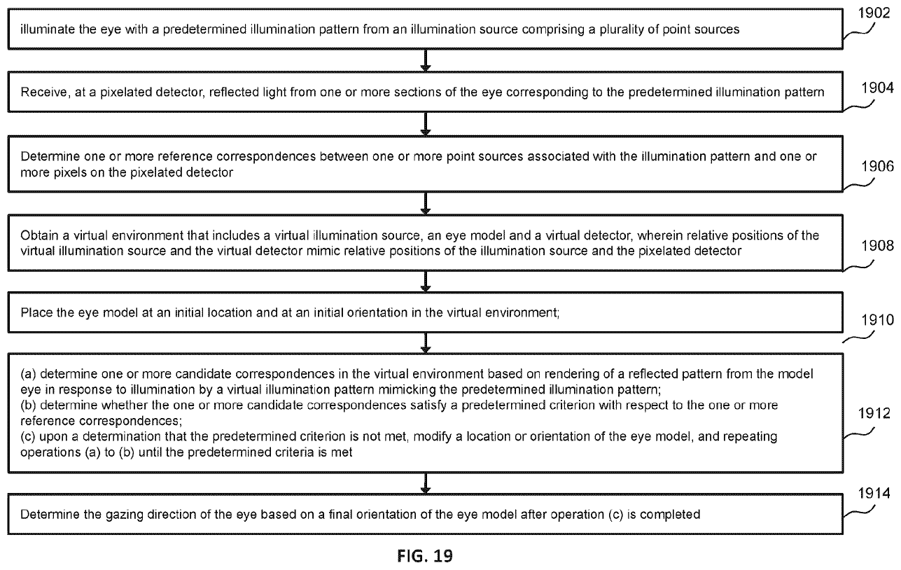

FIG. 19 illustrates a set of operations that can be carried out to determine a gazing direction of an eye in accordance with an example embodiment. At 1902, the eye is illuminated with a predetermined illumination pattern from an illumination source comprising a plurality of point sources. At 1904, reflected light from one or more sections of the eye corresponding to the predetermined illumination pattern is received at a pixelated detector. At 1906, one or more reference correspondences between one or more point sources associated with the illumination pattern and one or more pixels on the pixelated detector are determined. At 1908, a virtual environment is obtained that includes a virtual illumination source, an eye model and a virtual detector. The relative positions of the virtual illumination source and the virtual detector mimic relative positions of the illumination source and the pixelated detector. At 1910, the eye model is placed at an initial location and at an initial orientation in the virtual environment. The operations at 1912 include: (a) determining one or more candidate correspondences in the virtual environment based on rendering of a reflected pattern from the model eye in response to illumination by a virtual illumination pattern mimicking the predetermined illumination pattern; (b) determining whether the one or more candidate correspondences satisfy a predetermined criterion with respect to the one or more reference correspondences; and (c) upon a determination that the predetermined criterion is not met, modifying a location or orientation of the eye model, and repeating operations (a) to (b) until the predetermined criteria is met, At 1914, the gazing direction of the eye is determined based on a final orientation of the eye model after operation (c) is completed.

In one example embodiment, the predetermined illumination pattern comprises sinusoidal pattern. In another example embodiment, the predetermined illumination pattern is an arbitrary image that is displayed on a screen. In yet another example embodiment, the reflected light from the one or more sections of the eye corresponding to the predetermined illumination pattern forms a single image that suffices for determining the gazing direction of an eye without a need to obtain additional images of the eye. In still another example embodiment, the predetermined illumination pattern is produced by a screen that is part of a virtual reality or an augmented reality device, and wherein the illumination pattern is a single frame of a video or image content that is displayed on the screen while a user is interacting with the virtual reality or an augmented reality device.

According to one example embodiment, the one or more sections of the eye include at least part of a cornea and part of a sclera. In another example embodiment, the virtual illumination pattern is identical to the predetermined illumination pattern, the relative positions of the virtual illumination source and the virtual detector are identical to the relative positions of the illumination source and the pixelated detector, and the pixelated detector and the virtual detector have similar characteristics. In another example embodiment, the above note method for determining the gazing direction includes performing a calibration procedure prior to illuminating the eye with the predetermined illumination pattern to determine the relative positions of the illumination source and the pixelated detector, and one or more parameters of the pixelated detector. In still another example embodiment, determining whether the one or more candidate correspondences satisfy a predetermined criterion with respect to the one or more reference correspondences is based on a departure of the one or more candidate correspondences from the one or more reference correspondences.

In another example embodiment, operations (b) and (c) of FIG. 19 are performed as part of an optimization procedure that includes optimization of a function that is based on a departure of the one or more candidate correspondences from the one or more reference correspondences. In one example embodiment, the function has a square relationship with respect to a distance between the one or more candidate correspondences from the one or more reference correspondences. In another example embodiment, the optimization procedure includes a gradient descent algorithm. In still another example embodiment, operations (a) to (c) include using a scale-invariant feature transform (SIFT) feature matching to extract correspondence information.

In one example embodiment, the method for determining a gaze direction further includes determining an estimated shape of the eye by iteratively modifying one or more parameters associated with a shape of the eye model. In another example embodiment, iteratively modifying the one or more parameters associated with the eye model is performed as part of operations (a) to (c) (of FIG. 19) based on joint optimization of the orientation and the shape of the eye model. In still another example embodiment, the joint optimization includes using one or more regularizers. In another example embodiment, determining whether the one or more candidate correspondences satisfy the predetermined criterion with respect to the one or more reference correspondences includes determining whether the one or more candidate correspondences coincide with the one or more reference correspondences. In yet another example embodiment, an accuracy of the gazing direction determination is less than 0.05 degrees. In one example embodiment, the initial orientation of the eye model is arbitrarily selected. In some embodiments, the illumination pattern has a larger extent than the eye

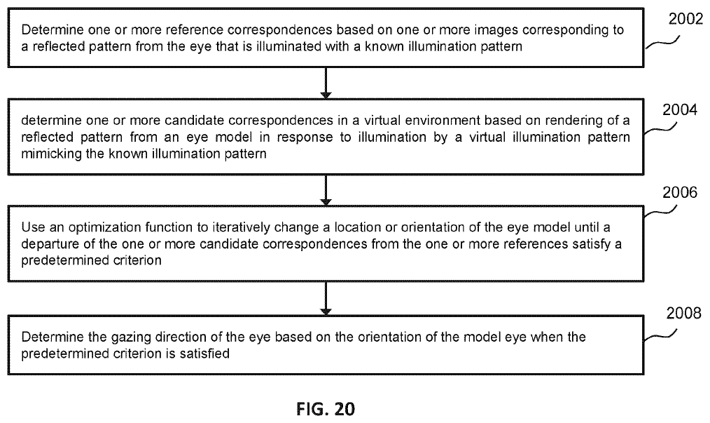

FIG. 20 illustrates another set of example operations that can be carried out to determine a gazing direction of an eye in accordance with some embodiments. At 2002, one or more reference correspondences are determined based on one or more images corresponding to the eye that is illuminated with a known illumination pattern. At 2004, one or more candidate correspondences are determine in a virtual environment based on rendering of a reflected pattern from an eye model in response to illumination by a virtual illumination pattern mimicking the known illumination pattern. At 2006, using an optimization function, a location or orientation of the eye model are iteratively changed until a departure of the one or more candidate correspondences from the one or more references satisfy a predetermined criterion. At 2008, the gazing direction of the eye is determined based on the orientation of the model eye when the predetermined criterion is satisfied.

Another aspect of the disclosed embodiments relates to a system that includes an illumination screen comprising a plurality of point sources and configured to illuminate an eye with a predetermined illumination pattern; the system also includes a pixelated detector positioned to receive reflected light from one or more sections of the eye corresponding to the predetermined illumination pattern. The system further includes a processor and a memory with instructions stored thereon, wherein the instructions upon execution by the processor cause the processor to: determine one or more reference correspondences between one or more point sources associated with the illumination pattern and one or more pixels on the pixelated detector; set up a virtual environment that includes a virtual illumination source, an eye model and a virtual detector, wherein relative positions of the virtual illumination source and the virtual detector mimic relative positions of the illumination source and the pixelated detector; position the eye model at an initial location and at an initial orientation in the virtual environment; (a) determine one or more candidate correspondences in the virtual environment based on rendering of a reflected pattern from the model eye in response to illumination by a virtual illumination pattern mimicking the predetermined illumination pattern; (b) determine whether the one or more candidate correspondences satisfy a predetermined criterion with respect to the one or more reference correspondences; (c) upon a determination that the predetermined criterion is not met, modify a location or orientation of the eye model, and repeat operations (a) to (b) until the predetermined criteria is met; and determine the gazing direction of the eye based on a final orientation of the eye model after operation (c) is completed.

In one example embodiment, the system is part of a virtual reality or an augmented reality device, and a screen of the virtual reality or augmented reality device is operable to produce the predetermined illumination pattern as a single frame of a video or image content that is displayed on the screen.

Another aspect of the disclosed embodiments relates to a method that uses deflectometric information for determining a gazing direction of an eye that includes illuminating the eye with an illumination pattern, wherein the illumination pattern has a larger extent than the eye, and is produced using a plurality of point sources. The method further includes receiving, at a pixelated detector, reflected light a from two or more sections of the eye corresponding to the illumination pattern, and determining a plurality of correspondences between point sources associated with the illumination pattern and pixels on the pixelated detector. The method additionally includes determining surface normals associated with the two more sections of the eye based on the plurality of correspondences, and determining the gazing direction based on a vector that connects a plurality of convergence points of the normals that are back-traced to interior region of the eye. For example, the two or more sections of the eye include a portion of the cornea and portion of the eye other than the cornea, such as the sclara. The plurality of convergence points can include two convergence points, where the first convergence point is obtained by back-tracing the surface normals corresponding to a first section of the eye, and the second convergence point is obtained by back-tracing the surface normals corresponding to a second section of the eye. In one example, where the eye shape is spherically symmetric, but not necessarily spherical, back-tracing of the surface normals results in a multiple points that lie on the same line that point to the gazing direction.

Various operations disclosed herein can be implemented using a processor/controller is configured to include, or be couple to, a memory that stores processor executable code that causes the processor/controller carry out various computations and processing of information. The processor/controller can further generate and transmit/receive suitable information to/from the various system components, as well as suitable input/output (IO) capabilities (e.g., wired or wireless) to transmit and receive commands and/or data. The processor/controller may receive the information associated with optical rays and material parameters, and further process that information to simulate or trace rays throughout an optical system.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Only a few implementations and examples are described and other implementations, enhancements and variations can be made based on what is described and illustrated in this patent document.

1. A method for determining a gazing direction of an eye, comprising:
illuminating the eye with a predetermined illumination pattern from an illumination source comprising a plurality of point sources;
receiving, at a pixelated detector, reflected light from one or more sections of the eye corresponding to the predetermined illumination pattern;
determining one or more reference correspondences between one or more point sources associated with the predetermined illumination pattern and one or more pixels on the pixelated detector;
obtaining a virtual environment that includes a virtual illumination source, an eye model and a virtual detector, wherein relative positions of the virtual illumination source and the virtual detector mimic relative positions of the illumination source and the pixelated detector;
placing the eye model at an initial location and at an initial orientation in the virtual environment;
(a) determining one or more candidate correspondences in the virtual environment based on rendering of a reflected pattern from the eye model in response to illumination by a virtual illumination pattern mimicking the predetermined illumination pattern;
(b) determining whether the one or more candidate correspondences satisfy a predetermined criterion with respect to the one or more reference correspondences;
(c) upon a determination that the predetermined criterion is not met, modifying a location or orientation of the eye model, and repeating operations (a) to (b) until the predetermined criterion is met; and
determining the gazing direction of the eye based on a final orientation of the eye model after operation (c) is completed.

2. The method of claim 1, wherein the predetermined illumination pattern (a) comprises a sinusoidal pattern or a checkerboard pattern, or (b) is an arbitrary image that is displayed on a screen.

3. (canceled)

4. The method of claim 1, wherein the reflected light from the one or more sections of the eye corresponding to the predetermined illumination pattern forms a single image that suffices for determining the gazing direction of an eye without a need to obtain additional images of the eye.

5. The method of claim 1, wherein the predetermined illumination pattern is produced by a screen that is part of a virtual reality or an augmented reality device, and wherein the predetermined illumination pattern is a single frame of a video or image content that is displayed on the screen while a user is interacting with the virtual reality or an augmented reality device.

6. The method of claim 1, wherein the one or more sections of the eye include at least part of a cornea and part of a sclera.

7. The method of claim 1, wherein the virtual illumination pattern is identical to the predetermined illumination pattern, the relative positions of the virtual illumination source and the virtual detector are identical to the relative positions of the illumination source and the pixelated detector, and the pixelated detector and the virtual detector have similar characteristics.

8. The method of claim 1, comprising performing a calibration procedure prior to illuminating the eye with the predetermined illumination pattern to determine the relative positions of the illumination source and the pixelated detector, and one or more parameters of the pixelated detector.

9. The method of claim 1, wherein determining whether the one or more candidate correspondences satisfy a predetermined criterion with respect to the one or more reference correspondences is based on a departure of the one or more candidate correspondences from the one or more reference correspondences.

10. The method of claim 1, wherein operations (b) and (c) are performed as part of an optimization procedure that includes optimization of a function that is based on a departure of the one or more candidate correspondences from the one or more reference correspondences.

11. The method of claim 10, wherein the function has a square relationship with respect to a distance between the one or more candidate correspondences from the one or more reference correspondences.

12. The method of claim 10, wherein the optimization procedure includes a gradient descent algorithm.

13. The method of claim 1, wherein operations (a) to (c) include using a scale-invariant feature transform (SIFT) feature matching to extract correspondence information.

14. The method of claim 1, further comprising determining an estimated shape of the eye by iteratively modifying one or more parameters associated with a shape of the eye model.

15. The method of claim 14, wherein iteratively modifying the one or more parameters associated with the eye model is performed as part of operations (a) to (c) based on joint optimization of the orientation and the shape of the eye model.

16. The method of claim 14, wherein the joint optimization includes using one or more regularizers.

17. The method of claim 1, wherein determining whether the one or more candidate correspondences satisfy the predetermined criterion with respect to the one or more reference correspondences includes determining whether the one or more candidate correspondences coincide with the one or more reference correspondences.

18. The method of claim 1, wherein the predetermined illumination pattern has a larger extent than the eye.

19. The method of claim 1, wherein the initial orientation of the eye model is arbitrarily selected.

20. A method for determining a gazing direction of an eye, comprising:
determining one or more reference correspondences based on one or more images corresponding to a reflected pattern from the eye that is illuminated with a known illumination pattern;
determining one or more candidate correspondences in a virtual environment based on rendering of a reflected pattern from an eye model in response to illumination by a virtual illumination pattern mimicking the known illumination pattern;
using an optimization function to iteratively change a location or orientation of the eye model until a departure of the one or more candidate correspondences from the one or more reference correspondences satisfy a predetermined criterion; and
determining the gazing direction of the eye based on the orientation of the eye model when the predetermined criterion is satisfied.

21. A system, comprising:
an illumination screen comprising a plurality of point sources and configured to illuminate an eye with a predetermined illumination pattern;
a pixelated detector positioned to receive reflected light from one or more sections of the eye corresponding to the predetermined illumination pattern;
a processor and a memory with instructions stored thereon, wherein the instructions upon execution by the processor cause the processor to:
determine one or more reference correspondences between one or more point sources associated with the illumination pattern and one or more pixels on the pixelated detector;
set up a virtual environment that includes a virtual illumination source, an eye model and a virtual detector, wherein relative positions of the virtual illumination source and the virtual detector mimic relative positions of the illumination screen and the pixelated detector;
position the eye model at an initial location and at an initial orientation in the virtual environment;
(a) determine one or more candidate correspondences in the virtual environment based on rendering of a reflected pattern from the eye model in response to illumination by a virtual illumination pattern mimicking the predetermined illumination pattern;
(b) determine whether the one or more candidate correspondences satisfy a predetermined criterion with respect to the one or more reference correspondences;
(c) upon a determination that the predetermined criterion is not met, modify a location or orientation of the eye model, and repeat operations (a) to (b) until the predetermined criterion is met; and
determine a gazing direction of the eye based on a final orientation of the eye model after operation (c) is completed.

22. The system of claim 21, wherein the predetermined illumination pattern comprises sinusoidal pattern or a checkerboard pattern or is an arbitrary image that is displayed on a screen.

23. (canceled)

24. The system of claim 21, wherein the reflected light from the one or more sections of the eye corresponding to the predetermined illumination pattern forms a single image that suffices for determining the gazing direction of an eye without a need to obtain additional images.

25. The system of claim 21, wherein the system is part of a virtual reality or an augmented reality device, and the illumination screen is a screen of the virtual reality or augmented reality device operable to produce the predetermined illumination pattern as a single frame of a video or image content that is displayed on the screen.

26. The system of claim 21, wherein the virtual illumination pattern is identical to the predetermined illumination pattern, the relative positions of the virtual illumination source and the virtual detector are identical to the relative positions of the illumination screen and the pixelated detector, and the pixelated detector and the virtual detector have similar characteristics.

27. The system of claim 21, wherein the instructions upon execution by the processor cause the processor to: determine whether the one or more candidate correspondences satisfy a predetermined criterion with respect to the one or more reference correspondences based on a departure of the one or more candidate correspondences from the one or more reference correspondences.

28. The system of claim 21, wherein the instructions upon execution by the processor cause the processor to perform operations (b) and (c) as part of an optimization procedure that includes optimization of a function that is based on a departure of the one or more candidate correspondences from the one or more reference correspondences.

29-35. (canceled)

36. The system of claim 21, wherein the initial orientation of the eye model is arbitrarily selected.

37. The system of claim 21, wherein the predetermined illumination pattern has a larger extent than the eye.
